(19) United States
(12) Patent Application Publication
(10) Pub. No.: US 2026/0128435 A1
(43) Pub. Date: May 7, 2026

(54) PACK HOUSING AND MANUFACTURING METHOD OF BATTERY PACK

(71) Applicants: Hyundai Motor Company, Seoul (KR); Kia Corporation, Seoul (KR)

(72) Inventors: Jong Gyu PARK, Hwaseong-si (KR); Kyung Mo KIM, Hwaseong-si (KR); Si Won KIM, Hwaseong-si (KR); Gun Woo KO, Hwaseong-si (KR)

(73) Assignees: Hyundai Motor Company, Seoul (KR); Kia Corporation, Seoul (KR)

(21) Appl. No.: 19/246,267

(22) Filed: Jun. 23, 2025

(30) Foreign Application Priority Data
Nov. 5, 2024 (KR) 10-2024-0155654

(51) Int. Cl. H01M 50/242; B60L 50/64; H01M 50/204; H01M 50/249; H01M 50/262

(52) U.S. Cl. CPC H01M 50/242; H01M 50/204; H01M 50/249; H01M 50/262; B60L 50/64; H01M 2220/20

(57) ABSTRACT

A pack housing includes a base plate, a side member that forms a receiving space together with the base plate and that is connected with the base plate, and a cross member that extends in a direction crossing the side member. The side member includes an inner sidewall that faces the receiving space and a guide holder that protrudes toward the receiving space from the inner sidewall and forms a guide hole into which the cross member is inserted.

### CROSS-REFERENCE TO RELATED APPLICATION

This application claims the benefit of priority to Korean Patent Application No. 10-2024-0155654, filed in the Korean Intellectual Property Office on Nov. 5, 2024, the entire contents of which are incorporated herein by reference in their entireties.

### TECHNICAL FIELD

The present disclosure relates to a pack housing and a manufacturing method of a battery pack.

### BACKGROUND

In recent years, there has been a marked emphasis on research and development for electric vehicles (EVs), which are recognized for their environmentally friendly characteristics, amidst the growing global concern over environmental degradation and the depletion of oil resources. This heightened urgency has spurred advancements in various categories related to electric vehicles, including plug-in hybrid electric vehicles (PHEVs), battery electric vehicles (BEVs), and fuel cell electric vehicles (FCEVs), among others. The shift towards EV technology holds promise for reducing greenhouse gas emissions, and also likely addresses the pressing need for sustainable alternatives to fossil fuel dependency.

The design of EVs are at time designed with a battery pack housing that provides structural support for the individual battery cells, which serves as the primary power source for the vehicle's propulsion system. In tandem with this foundational component, ongoing research is being directed towards enhancing the capacity and energy density of these battery cells within the housing to improve the overall performance, range, and efficiency of EVs.

To improve the capacity of battery cells, a cell-to-pack (CTP) configuration may be utilized in which the battery cells are directly integrated into the pack housing as a unified battery cell stack instead of being organized in discrete modules. This approach allows for increased energy density and improved thermal management, leading to a more efficient electrical performance. Furthermore, the integration of the battery cell stack within the pack housing may necessitate the incorporation of other structural elements, such as a cross member, which can have an important role in distributing the surface pressure exerted on the battery cell stack during operation. This structural support can be important for maintaining integrity and longevity of the battery system under various conditions.

In view of the above, there is a significant demand for improved and simplified structural designs that facilitate the assembly of the cross member while ensuring its stability and effectiveness in supporting the battery cell stack. Such a design that minimizes the complexity can lead to reduced manufacturing costs and enhanced reliability of the battery system. Additionally, innovations aimed at optimizing the cross member's integration within the pack housing can result in improved overall performance, thus contributing to the advancement of battery technology. Such improved and simplified structural designs should identify efficient materials and designs that not only meet the structural requirements but also align with contemporary sustainability standards in battery manufacturing.

### SUMMARY

The present disclosure has been made to solve the above-mentioned problems.

In embodiments, the present disclosure provides a pack housing for easily assembling a cross member and stably supporting the cross member.

The technical problems to be solved by the present disclosure are not limited to the aforementioned problems, and any other technical problems not mentioned herein will be clearly understood from the following description by those skilled in the art to which the present disclosure pertains.

In embodiments, the present disclosure provides a pack housing comprises a base plate, a side member that forms a receiving space together with the base plate and that is connected with the base plate, and a cross member that extends in a direction crossing the side member. The side member comprises an inner sidewall that faces the receiving space and a guide holder that protrudes toward the receiving space from the inner sidewall and forms a guide hole into which the cross member is inserted.

In embodiments, the guide holder comprises a pair of holder walls that protrude toward the receiving space from the inner sidewall, and the guide hole may be located between the pair of holder walls.

Each of the pair of holder walls may extend in one direction perpendicular to the base plate, and the guide hole may extend in the one direction along the pair of holder walls.

The cross member may be inserted into the guide hole in the one direction.

In embodiments, the guide holder comprises a connection wall that connects the pair of holder walls and that is brought into contact with the inner sidewall, the connection wall including an inner connection surface that faces toward the guide hole and an interference member that is brought into contact with the inner connection surface and that interferes with the cross member.

The interference member may interfere with the cross member, may allow the cross member to be inserted in one direction toward the guide hole, and may prevent the cross member from being withdrawn from the guide hole in an opposite direction opposite to the one direction.

In embodiments, the interference member comprises a support area brought into contact with the inner connection surface and an interference protrusion area that protrudes toward the guide hole from the support area and interferes with the cross member.

In embodiments, the interference member comprises a protruding area that is connected to the support area and that protrudes from the support area and a cross member contact area that extends from the protruding area and that is spaced apart from the support area.

The protruding area may have an inclined shape to form certain angles with one direction in which the cross member is inserted into the guide hole and a direction toward the cross member.

In embodiments, the cross member comprises a guide surface disposed parallel to the support area and brought into contact with the interference protrusion area and an interference surface that protrudes toward the support area from the guide surface and interferes with one end of the interference protrusion area.

In embodiments, each of the pair of the holder walls comprises an inner holder surface that faces the guide hole and an inlet holder surface that extends from the inner holder surface to have a certain angle with respect to an opposite direction opposite to the one direction, the inlet holder surface being formed such that a cross-sectional area of the guide hole on a plane perpendicular to the one direction is increased in the opposite direction.

In embodiments, the guide holder comprises a connection wall that connects the pair of holder walls and that is brought into contact with the inner sidewall, and the connection wall, in embodiments, comprises an inner connection surface that faces the guide hole and an inlet connection surface that extends from the inner connection surface to have a certain angle with respect to an opposite direction opposite to the one direction, the inlet connection surface being formed such that a cross-sectional area of the guide hole on a plane perpendicular to the one direction is increased in the opposite direction.

In embodiments, the present disclosure provides a method for manufacturing a battery pack comprises preparing a base plate and a side member that form a receiving space together, mounting battery cell stacks in the receiving space, and inserting a cross member between the battery cell stacks after the cell mounting step. The side member comprises an inner sidewall that faces the receiving space and a guide holder that protrudes toward the receiving space from the inner sidewall to form a guide hole, and the inserting the cross member between the battery cell stacks comprises inserting the cross member into the guide hole.

The guide hole may extend in one direction perpendicular to the base plate, and the inserting the cross member between the battery cell stacks comprises inserting the cross member into the guide hole in the one direction.

In embodiments, the guide holder comprises an interference member that is provided in the guide hole and that interferes with the cross member, and the inserting the cross member between the battery cell stacks, in embodiments, comprises inserting the cross member into the guide hole until the cross member interferes with the interference member within the guide hole.

### BRIEF DESCRIPTION OF THE DRAWINGS

The above and other objects, features and advantages of the present disclosure will be more apparent from the following detailed description taken in conjunction with the accompanying drawings:

FIG. 1 is an exploded perspective view of a battery pack according to an embodiment of the present disclosure;

FIG. 2 is an enlarged view of a pack housing according to an embodiment of the present disclosure;

FIG. 3 is an enlarged view of an inner sidewall and a guide holder according to an embodiment of the present disclosure;

FIG. 4 is an enlarged view illustrating a cross member inserted into the guide holder according to an embodiment of the present disclosure;

FIG. 5 is a vertical sectional view illustrating the cross member inserted into the guide holder according to an embodiment of the present disclosure;

FIG. 6 is an enlarged view of portion A illustrated in FIG. 5;

FIG. 7 is a flowchart illustrating a manufacturing method of the battery pack according to an embodiment of the present disclosure;

FIG. 8 is a perspective view of the pack housing in a preparation step according to an embodiment of the present disclosure;

FIG. 9 is a perspective view of the pack housing and battery cell stacks in a cell mounting step according to an embodiment of the present disclosure;

FIG. 10 is an enlarged view of the guide holder and the battery cell stacks illustrated in FIG. 9;

FIG. 11 is a perspective view of the pack housing and the battery cell stacks in a cross member mounting step according to an embodiment of the present disclosure; and

FIG. 12 is an enlarged view of the cross member inserted into the guide holder illustrated in FIG. 11.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

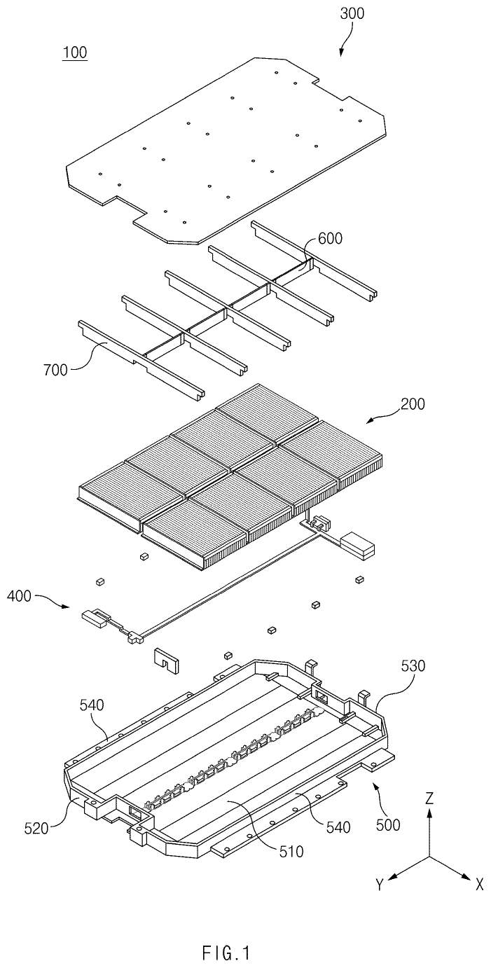

Hereinafter, embodiments of the present disclosure will be described in detail with reference to FIGS. 1 to 12.

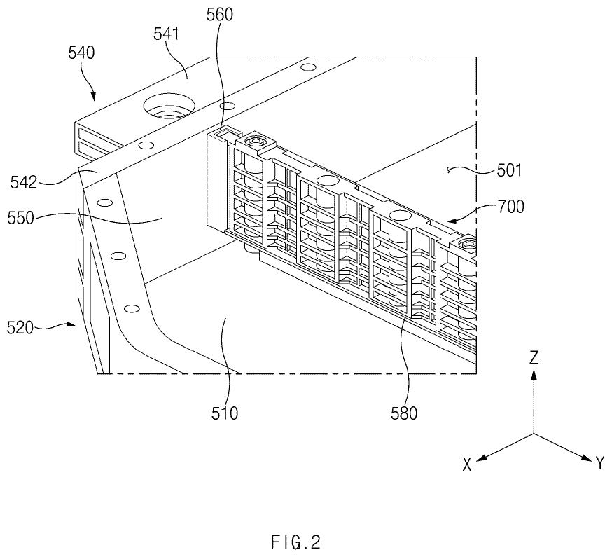

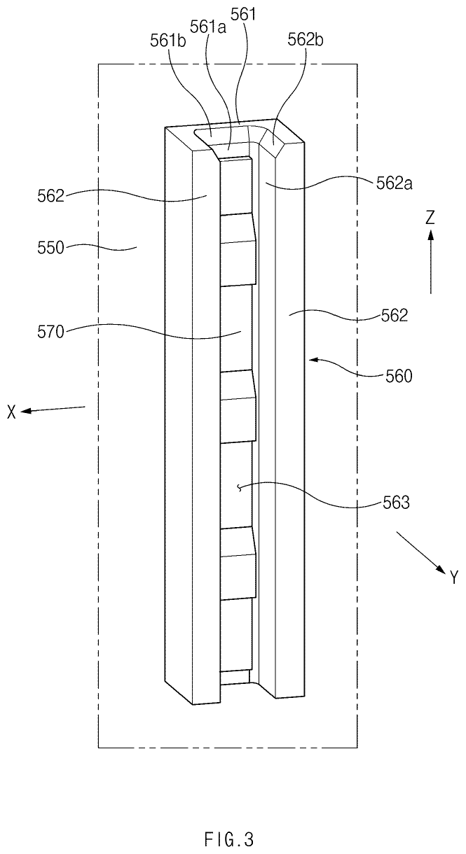

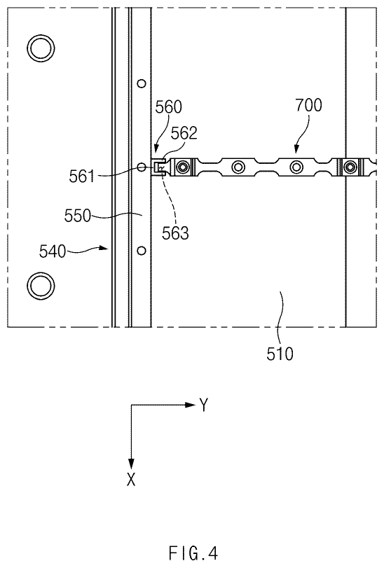

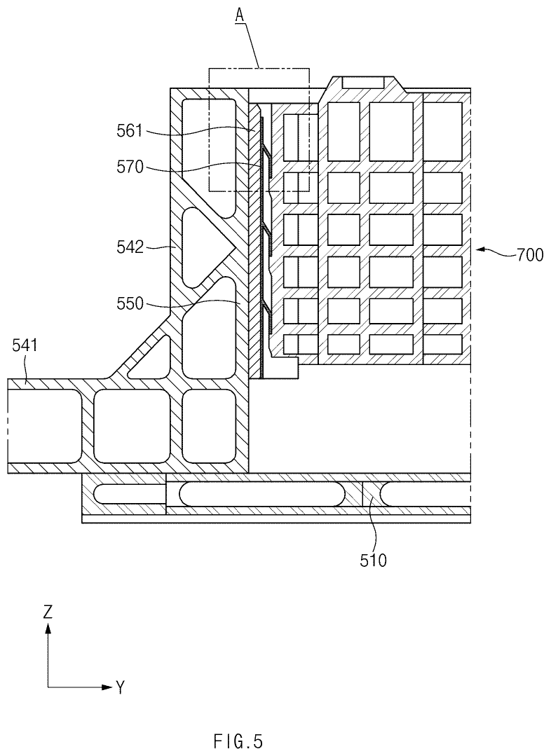

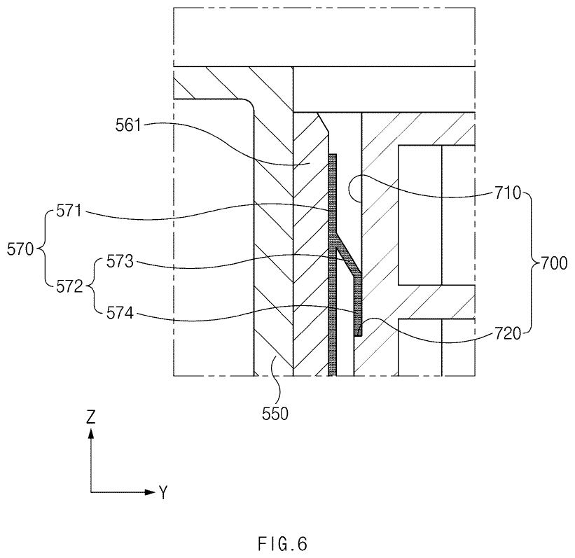

FIG. 1 is an exploded perspective view of a battery pack according to an embodiment of the present disclosure. FIG. 2 is an enlarged view of a pack housing according to an embodiment of the present disclosure. FIG. 3 is an enlarged view of an inner sidewall and a guide holder according to an embodiment of the present disclosure. FIG. 4 is an enlarged view illustrating a cross member inserted into the guide holder according to an embodiment of the present disclosure. FIG. 5 is a vertical sectional view illustrating the cross member inserted into the guide holder according to an embodiment of the present disclosure. FIG. 6 is an enlarged view of portion A illustrated in FIG. 5.

Referring to FIGS. 1 to 6, the battery pack 100 may include a battery cell stack 200, a pack cover 300, an electronic module 400, and the pack housing 500.

The battery cell stack 200 may include battery cells that supply power to an electric vehicle. The battery cells may be arranged in a first direction (an X direction or a direction opposite to the X direction) and may extend in a second direction (a Y direction or a direction opposite to the Y direction) perpendicular to the first direction.

The battery cell stack 200 may be provided in plural and may be accommodated in the pack housing 500. The battery cell stacks 200 may be mounted in the pack housing 500 with the plurality of battery cells stacked, rather than in a module form equipped with a module housing.

The pack cover 300 may cover areas of the battery cell stacks 200 that face toward one side in a third direction (face in a Z direction). The third direction may be a direction perpendicular to the first direction and the second direction. The pack cover 300 may be coupled with the pack housing 500 and may cover the battery cell stacks 200.

The battery cell stacks 200 may be connected with the electronic module 400. The electronic module 400 may include a busbar or wire connected with each of the plurality of battery cell stacks 200.

The electronic module 400 may transmit power generated from the battery cell stack 200 to other parts of the electric vehicle through the busbar or wire. In addition, the electronic module 400 may sense the temperature or voltage of the battery cell stack 200 and may control the battery cells based on the state of the battery cells.

The pack housing 500 may include a base plate 510, a front member 520, a rear member 530, and side members 540. The front member 520, the rear member 530, and the side members 540 may extend along the periphery of the base plate 510.

The front member 520, the rear member 530, and the side members 540, together with the base plate 510, may form a receiving space 501 in which the battery cell stacks 200 are accommodated.

The front member 520 may cover an area of the receiving space 501 that faces toward one side in the first direction (faces in the X direction). The front member 520 may be connected to the base plate 510 and may be coupled to the base plate 510.

The rear member 530 may cover an area of the receiving space 501 that faces toward an opposite side in the first direction (faces in the direction opposite to the X direction). The rear member 530 may be connected to the base plate 510 and may be coupled to the base plate 510.

The side members 540 may be provided in a pair and may cover areas of the receiving space 501 that face toward opposite sides in the second direction (face in the Y direction or the direction opposite to the Y direction). The side members 540 may extend in the first direction and may be connected to the front member 520 and the rear member 530.

The side members 540 may be connected to the base plate 510 and may be coupled to the base plate 510. Each of the side members 540 may include a flange 541 and a side part 542.

The side part 542 may be connected to the front member 520 and the rear member 530 and may cover the receiving space 501. The flange 541, which is a part for fixing the battery pack 100 to the electric vehicle, may protrude from the side part 542 to face away from the receiving space 501.

Meanwhile, the base plate 510, the front member 520, the rear member 530, and the side members 540 may be provided as separate components, but may be implemented with one component.

The pack housing 500 may include a middle member 600 and the cross member 700 that are accommodated in the receiving space 501. The middle member 600 may extend between the front member 520 and the rear member 530 in the first direction. The middle member 600 may be provided in plural. Each of the plurality of middle members 600 may be disposed between a pair of cross members 700 adjacent to each other.

The middle member 600 may be provided between a pair of battery cell stacks 200 spaced apart from each other in the second direction among the plurality of battery cell stacks 200. The middle member 600 may support or cover the wire or busbar of the electronic module 400.

The cross member 700 may extend between the pair of side members 540 in a direction crossing the side members 540. The cross member 700 may extend in a direction crossing the middle members 600. The cross member 700 may be provided in plural. The plurality of cross members 700 may be spaced apart from one another in the first direction and may extend in the second direction.

Each of the cross members 700 may be disposed between a pair of battery cell stacks 200 spaced apart from each other in the first direction. The cross members 700 may be located at opposite ends of the battery cell stacks 200 in the first direction and may prevent the battery cells from swelling in the first direction.

The middle members 600 and the cross members 700 may be coupled to the base plate 510, and the positions of middle members 600 and the cross members 700 may be fixed accordingly. Opposite ends of each of the cross members 700 in the second direction may face toward the pair of side members 540, respectively. The cross member 700 may be supported by the pair of side members 540.

In more detail, the side part 542 of each of the side members 540 may include the inner sidewall 550 facing the receiving space 501 and the guide holder 560 protruding toward the receiving space 501 from the inner sidewall 550.

The guide holder 560 may be provided in plural. The plurality of guide holders 560 may be spaced apart from one another in the first direction. The number of guide holders 560 for each of the pair of side members 540 may correspond to the number of cross members 700.

The guide holders 560 may be formed on the inner sidewall 550 of the side member 540 and may be open toward the receiving space 501. The guide holders 560 may extend in the third direction (the Z direction or a direction opposite to the Z direction).

The guide holders 560 may support the cross members 700, respectively. The guide holder 560 may include a guide hole 563 into which the cross member 700 is inserted. The cross member 700 may be inserted into the guide hole 563.

The cross member 700 inserted into the guide hole 563 may be supported by a cross support member 580. The cross support member 580 may be disposed on the base plate 510 to face toward the one side in the third direction (face in the Z direction). When compared to the guide holder 560, the cross support member 580 may be disposed to face toward an opposite side in the third direction (face in the direction opposite to the Z direction).

The guide holder 560 may include a connection wall 561 and a pair of holder walls 562. The pair of holder walls 562 may protrude toward the receiving space 501 from the inner sidewall 550, and the guide hole 563 may be provided between the pair of holder walls 562.

The connection wall 561 may connect the pair of holder walls 562 and may be brought into contact with the inner sidewall 550. The connection wall 561 and the pair of holder walls 562 may form three sides of the guide hole 563 together.

The connection wall 561 and the pair of holder walls 562 may all extend in the third direction, and accordingly the guide hole 563 may extend in the third direction along the connection wall 561 and the pair of holder walls 562.

The connection wall 561 may include an inner connection surface 561a facing the guide hole 563. The connection wall 561 may include an inlet connection surface 561b connected to the inner connection surface 561a.

The inner connection surface 561a may extend in the third direction. The inlet connection surface 561b may have an inclined shape to have a certain angle from the inner connection surface 561 toward the one side in the third direction and the inner sidewall 550.

Each of the holder walls 562 may include an inner holder surface 562a facing the guide hole 563. The holder wall 562 may include an inlet holder surface 562b connected to the inner holder surface 562a.

The inner holder surface 562a may extend in the third direction. The inlet holder surface 562b may have an inclined shape to have a certain angle from the inner holder surface 562a toward the one side in the third direction and the outside of the guide hole 563 in the first direction.

When the cross member 700 is inserted into the guide hole 563 toward the base plate 510, the inlet connection surface 561b and the inlet holder surface 562b may guide the insertion of the cross member 700.

The inlet connection surface 561b may extend from the inner connection surface 561a to have a certain angle with respect to the one side in the third direction and may be formed such that the cross-sectional area of the guide hole 563 on a plane perpendicular to the third direction is increased toward the one side in the third direction.

Likewise, the inlet holder surface 562b may extend from the inner holder surface 562a to have a certain angle with respect to the one side in the third direction and may be formed such that the cross-sectional area of the guide hole 563 on the plane perpendicular to the third direction is increased toward the one side in the third direction.

Due to the above-described structure, when the cross member 700 is inserted into the guide hole 563 toward the opposite side in the third direction, the cross member 700 may be brought into contact with the inlet connection surface 561b or the inlet holder surface 562b and may slide into the guide hole 563.

That is, the insertion of the cross member 700 into the guide hole 563 may be guided while the cross member 700 moves toward the opposite side in the third direction, and thus a manufacturing process of the battery pack 100 including the cross member 700 may be facilitated.

In addition, the guide holder 560 may include an interference member 570 that is brought into contact with the inner connection surface 561a and that interferes with the cross member 700. The interference member 570 may be located in the guide hole 563.

The interference member 570, while interfering with the cross member 700, may allow the cross member 700 to be inserted into the guide hole 563 toward the opposite side in the third direction, but may prevent the cross member 700 from being withdrawn from the guide hole 563 toward the one side in the third direction.

The interference member 570 may be a component for fixing the position of the cross member 700 in the guide hole 563 even without a separate fixing member for fixing the cross member 700.

The interference member 570 may include a support area 571 brought into contact with the inner connection surface 561a and an interference protrusion area 572 protruding toward the guide hole 563 from the support area 571. The interference protrusion area 572 may be a part interfering with the cross member 700.

The interference protrusion area 572 may include a protruding area 573 that is connected to the support area 571 and that protrudes from the support area 571 and a cross member contact area 574 that extends from the protruding area 573 and that is spaced apart from the support are 571.

The protruding area 573 may protrude toward the cross member 700 from the support area 571. The protruding area 573 may have an inclined shape to form certain angles with the opposite side in the third direction and the direction toward the cross member 700.

The cross member contact area 574 may extend from the protruding area 573 toward the opposite side in the third direction. The cross member contact area 574 may be brought into contact with the cross member 700 and may prevent the cross member 700 from being withdrawn toward the one side in the third direction.

In more detail, the cross member 700 may include a guide surface 710 disposed parallel to the support area 571 and brought into contact with the interference protrusion area 572 and an interference surface 720 protruding toward the support area 571 from the guide surface 710 and interfering with one end of the interference protrusion area 572. The one end of the interference protrusion area 572 may be one end of the cross member contact area 574.

The interference surface 720 may protrude from the guide surface 710 in a horizontal direction. The interference surface 720 may be formed to be stopped by the one end of the cross member contact area 574. In this case, the one end of the cross member contact area 574 may be disposed on the opposite side to an opposite end of the cross member contact area 574 connected with the protruding area 573.

The one end of the interference protrusion area 572 may be a free end. As the cross member 700 is inserted into the guide hole 563, the one end of the interference protrusion area 572 may interfere with the cross member 700 and may be deformed.

When the cross member 700 continues to be inserted, the position of the one end of the interference protrusion area 572 may be restored. This is because the opposite end of the interference protrusion area 572 connected with the support area 571 is a fixed end. Thereafter, the one end of the interference protrusion area 572 may be seated on the interference surface 720.

By the above-described process, the cross member 700 may be allowed to be inserted into the guide hole 563 toward the opposite side in the third direction, but may be prevented from being withdrawn from the guide hole 563 toward the one side in the third direction.

That is, the positions of the opposite ends of the cross member 700 in the second direction may be fixed by fixing only the cross member 700 and the base plate 510 without a separate coupling member, and thus the structural stability of the battery pack 100 and the durability of the battery pack 100 may be improved.

In addition, since the position of the cross member 700 is fixed by the guide holder 560, the battery cell stacks 200 may be prevented from swelling toward the opposite sides in the first direction.

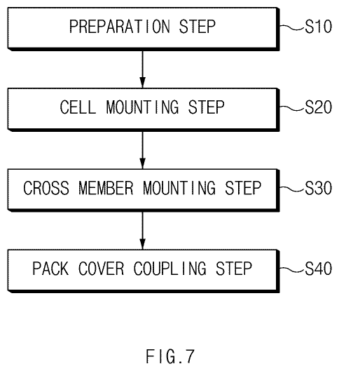

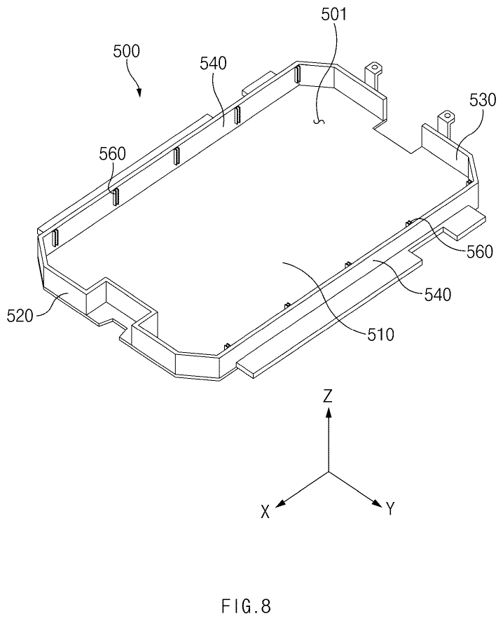

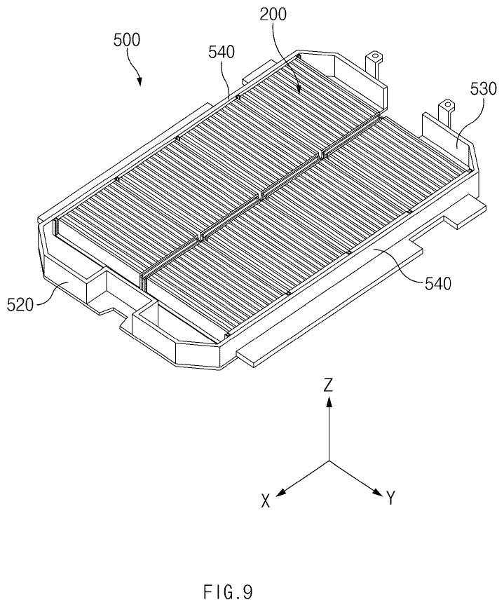

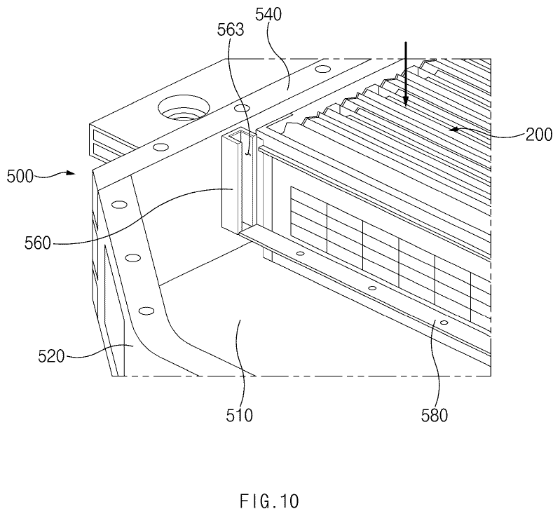

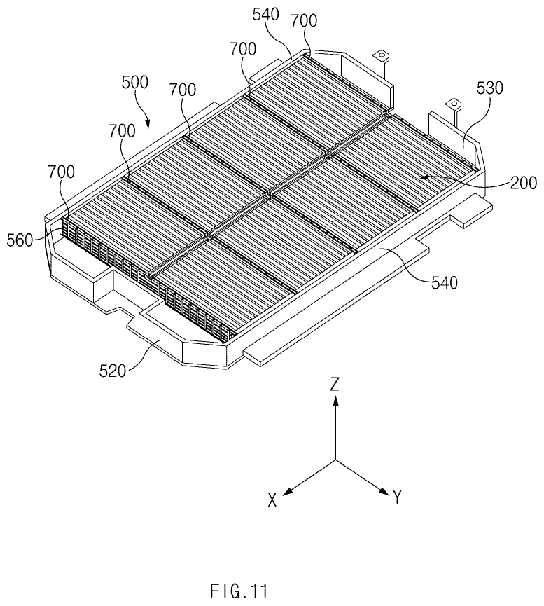

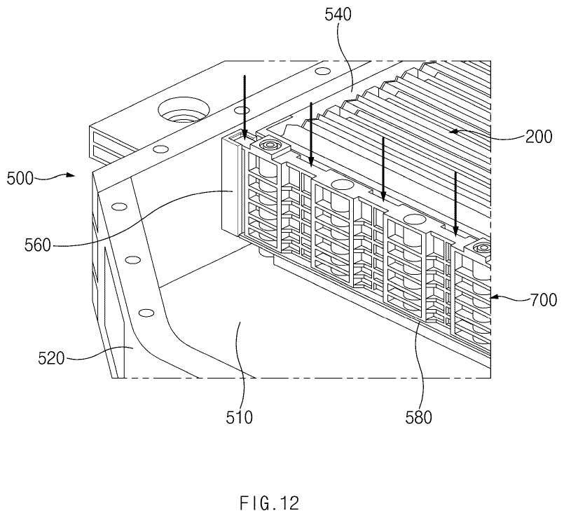

FIG. 7 is a flowchart illustrating a manufacturing method of the battery pack according to an embodiment of the present disclosure. FIG. 8 is a perspective view of the pack housing in a preparation step according to an embodiment of the present disclosure. FIG. 9 is a perspective view of the pack housing and the battery cell stacks in a cell mounting step according to an embodiment of the present disclosure. FIG. 10 is an enlarged view of the guide holder and the battery cell stacks illustrated in FIG. 9. FIG. 11 is a perspective view of the pack housing and the battery cell stacks in a cross member mounting step according to an embodiment of the present disclosure. FIG. 12 is an enlarged view of the cross member inserted into the guide holder illustrated in FIG. 11.

Referring to FIGS. 7 to 12, the manufacturing method of the battery pack 100 (refer to FIG. 1) may include a preparation step S10, a cell mounting step S20, a cross member mounting step S30, and a pack cover coupling step S40.

The preparation step S10 may be a step of preparing the base plate 510 and the side members 540, which form the receiving space 501 together, as illustrated in FIG. 8.

The preparation step S10 may be a step of preparing to open one side of the receiving space 501 in the third direction by coupling the base plate 510, the front member 520, the rear member 530, and the side members 540 of the pack housing 500.

The cell mounting step S20 may be a step of mounting the battery cells stacks 200 in the receiving space 501 as illustrated in FIGS. 9 and 10. The battery cells of the battery cell stacks 200 may be arranged in the first direction and may extend in the second direction, but are not limited thereto.

In the cell mounting step S20, the battery cell stacks 200 may be mounted in the receiving space 501 from one area of the receiving space 501 that faces in the third direction. At this time, the battery cell stacks 200 may be seated in the receiving space 501 while avoiding the positions of the guide holders 560.

In the cell mounting step S20, the positions of the battery cell stacks 200 may be guided by the guide holders 560, and accordingly the manufacturing process of the battery pack 100 may be relatively easy. Thus, the productivity of the battery pack 100 may be improved.

The guide holes 563 of the guide holders 560 may be formed to be open toward the one side in the third direction and may extend toward the opposite side in the third direction. The guide holders 560 may be disposed at positions that do not interfere with the battery cell stacks 200, and thus the positions of the guide holes 563 may be identified even though the guide holders 560 are viewed from the one side in the third direction after the cell mounting step S20.

The cross member mounting step S30 may be a step of inserting the cross members 700 between the battery cell stacks 200 as illustrated in FIGS. 11 and 12 after the cell mounting step S20. The cross member mounting step S30 may include the insertion of the cross members 700 into the guide holes 563.

Each of the cross members 700 may be inserted into the receiving space 501 between a pair of battery cell stacks 200 spaced apart from each other in the first direction. That is, the cross member 700 may also be moved from the one area of the receiving space 501 that faces in the third direction toward the opposite side in the third direction.

In the cross member mounting step S30, the cross members 700 may be inserted into the guide holes 563 toward the opposite side in the third direction. At this time, as illustrated in FIG. 3, the insertion of the cross members 700 into the guide holes 563 may be guided by the inlet connection surfaces 561b and the inlet holder surfaces 562b.

The cross member mounting step S30 may include a step of inserting the cross members 700 into the guide holes 563 until the cross members 700 interfere with the interference members 670 within the guide holes 563.

Thereafter, the cross members 700 may be fixed by a coupling process of coupling the cross members 700, the cross support members 580, and the base plate 510.

Since the positions of the cross members 700 are guided by the guide holes 563 in the cross member mounting step S30, the manufacturing process of the battery pack 100 may be relatively easy, and thus the productivity of the battery pack 100 may be improved.

In addition, since the positions of the cross members 700 are fixed by the interference members 570 even without separate coupling members in the cross member mounting step S30, a coupling process of the coupling members may be omitted, and the productivity of the battery pack 100 may be improved.

Thereafter, the electronic module 400 (refer to FIG. 1) and the middle members 600 may also be mounted in the receiving space 501. The assembly sequence of the electronic module 400, the middle members 600, and the cross members 700 is not limited thereto, and the cross members 700 may be mounted in the receiving space 501 after the electronic module 400 and the middle members 600 are mounted in the receiving space 501.

The pack cover coupling step S40 may be performed after the battery cell stacks 200, the middle members 600, and the cross members 700 are coupled to the base plate 510 as described above.

The pack cover coupling step S40 may be a step of coupling the pack cover 300 (refer to FIG. 1), which is disposed on the one side of the battery cell stacks 200 in the third direction, with the front member 220, the rear member 230, and the side members 240.

When the preparation step S10, the cell mounting step S20, the cross member mounting step S30, and the pack cover coupling step S40 are performed as described above, the manufacture of the battery pack 100 may be completed.

As described above, the positions where the cross members are inserted into the receiving space may be guided by the guide holes, and thus the manufacture of the battery pack may be facilitated.

Further, the cross members may interfere with the interference members, and thus the cross members may be prevented from being withdrawn from between the battery cell stacks.

Furthermore, the cross members may be stably supported between the battery cell stacks by the guide holes, and thus the pressure of the battery cell stacks may be maintained.

Moreover, the cross members may be fixed between the battery cell stacks without separate coupling members, and thus the manufacture of the battery pack may be facilitated.

In addition, the present disclosure may provide various effects that are directly or indirectly recognized.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. A pack housing comprising:
a base plate;
a side member configured to form a receiving space together with the base plate and connected with the base plate; and
a cross member configured to extend in a direction crossing the side member,
wherein the side member comprises:
an inner sidewall configured to face the receiving space; and
a guide holder configured to protrude toward the receiving space from the inner sidewall and form a guide hole into which the cross member is inserted.

2. The pack housing of claim 1, wherein the guide holder comprises a pair of holder walls configured to protrude toward the receiving space from the inner sidewall, the guide hole being located between the pair of holder walls.

3. The pack housing of claim 2, wherein each of the pair of holder walls extends in one direction perpendicular to the base plate, and wherein the guide hole extends in the one direction along the pair of holder walls.

4. The pack housing of claim 3, wherein the cross member is inserted into the guide hole in the one direction.

5. The pack housing of claim 2, wherein the guide holder further comprises:
a connection wall configured to connect the pair of holder walls and brought into contact with the inner sidewall, the connection wall including an inner connection surface configured to face toward the guide hole; and
an interference member brought into contact with the inner connection surface and configured to interfere with the cross member.

6. The pack housing of claim 5, wherein the interference member interferes with the cross member, allows the cross member to be inserted in one direction toward the guide hole, and prevents the cross member from being withdrawn from the guide hole in an opposite direction opposite to the one direction.

7. The pack housing of claim 5, wherein the interference member comprises: a support area brought into contact with the inner connection surface; and an interference protrusion area configured to protrude toward the guide hole from the support area and interfere with the cross member.

8. The pack housing of claim 7, wherein the interference protrusion area comprises: a protruding area connected to the support area and configured to protrude from the support area; and a cross member contact area configured to extend from the protruding area and spaced apart from the support area.

9. The pack housing of claim 8, wherein the protruding area has an inclined shape to form certain angles with one direction in which the cross member is inserted into the guide hole and a direction toward the cross member.

10. The pack housing of claim 7, wherein the cross member comprises:
a guide surface disposed parallel to the support area and brought into contact with the interference protrusion area; and
an interference surface configured to protrude toward the support area from the guide surface and interfere with one end of the interference protrusion area.

11. The pack housing of claim 3, wherein each of the pair of the holder walls comprises:
an inner holder surface configured to face the guide hole; and
an inlet holder surface configured to extend from the inner holder surface to have a certain angle with respect to an opposite direction opposite to the one direction, the inlet holder surface being formed such that a cross-sectional area of the guide hole on a plane perpendicular to the one direction is increased in the opposite direction.

12. The pack housing of claim 3, wherein the guide holder further comprises a connection wall configured to connect the pair of holder walls and brought into contact with the inner sidewall, and
wherein the connection wall comprises:
an inner connection surface configured to face the guide hole; and
an inlet connection surface configured to extend from the inner connection surface to have a certain angle with respect to an opposite direction opposite to the one direction, the inlet connection surface being formed such that a cross-sectional area of the guide hole on a plane perpendicular to the one direction is increased in the opposite direction.

13. A method for manufacturing a battery pack, the method comprising:
preparing a base plate and a side member configured to form a receiving space together;
mounting battery cell stacks in the receiving space; and
inserting a cross member between the battery cell stacks after the cell mounting step,
wherein the side member comprises:
an inner sidewall configured to face the receiving space; and
a guide holder configured to protrude toward the receiving space from the inner sidewall to form a guide hole, and
wherein the inserting the cross member between the battery cell stacks comprises inserting the cross member into the guide hole.

14. The method of claim 13, wherein the guide hole extends in one direction perpendicular to the base plate, and wherein the inserting the cross member between the battery cell stacks further comprises inserting the cross member into the guide hole in the one direction.

15. The method of claim 13, wherein the guide holder comprises an interference member provided in the guide hole and configured to interfere with the cross member, and wherein the inserting the cross member between the battery cell stacks further comprises inserting the cross member into the guide hole until the cross member interferes with the interference member within the guide hole.
